(19) United States
(12) Patent Application Publication
(10) Pub. No.: US 2007/0105967 A1
(43) Pub. Date: May 10, 2007

(54) Thermoplastic material

(76) Inventors: Govind Rauniyar, Roosendaal (NL); Mariska Snoeijers, AT Stampersgat (NL); Nancy Koch-Suikerbuik, DH Tholen (NL); Carl Goodwin, St. Crepin aux Bois (FR)

Correspondence Address: NOVA Chemicals Inc.;Patent Department, 400 Frankfort Road, Monaca, PA, 15061, US

(21) Appl. No.: 11/268,821

(22) Filed: Nov. 8, 2005

(51) Int. Cl. C08J 9/16

(52) U.S. Cl. 521/56

(57) ABSTRACT

The present invention provides a thermoplastic composition prepared by providing a mixture of ethylenically unsaturated monomers containing one or more styrenic monomers, one or more waxes, one or more white oils, and a particulate solid; polymerizing the monomers in the mixture in the presence of one or more free radical catalysts to form expandable particles; incorporating a blowing agent into the expandable particles; and at least partially expanding the expandable particles to provide expanded particles. Foamed articles can be prepared by feeding pre-expanded particles of the thermoplastic composition to a mold, heating the mold and expanded particles to a temperature sufficient to further expand the particles and cause the pre-expanded particles to soften and stick together, and cooling the mold to provide a foamed article.

### BACKGROUND OF THE INVENTION

1. Field of the Invention

The present invention is directed to novel generally non- or low-thermally conductive thermoplastic materials, methods of their use and methods of their manufacture that are generally useful in the construction and building trades. More specifically, the materials of the present invention can be used in construction and building applications that benefit from low thermal conductivity, light weight and improved insulation properties.

2. Description of the Prior Art

It is known that particles of polyvinylarenes, such as polystyrene, can be rendered expandable and that the particles thus obtained can be used in the preparation of foamed articles. For example, U.S. Pat. No. 2,681,321 discloses a process in which polystyrene particles are exposed to liquid hydrocarbons and treated such that the liquid hydrocarbon is dispersed in the polystyrene particles. Particles thus prepared contain generally 4 to 8 wt. % of liquid hydrocarbon blowing agents, such as butane, n-pentane or mixtures of pentanes. These particles can then be expanded to beads with a reduced density. Apparent densities for packaging particles are typically 20 to 60 kg/m³. Once expanded, the particles are fused in a steam-heated mould to yield a foamed article of a desired shape.

U.S. Pat. No. 6,538,042 discloses porous polyvinylarene particles having an apparent density do of 600 to 200 kg/M3, which contain a nucleating agent and 2.0 wt. % or less, based on the amount of polyvinylarene, of a volatile organic blowing agent. The particles can be used in the preparation of expanded particles and foamed articles.

It is known in the art that the thermal conductivity of foams can be reduced by incorporation of athermanous materials such as carbon black, metal oxides, metal powder or pigments.

For example, EP-A 372 343 discloses polystyrene foams containing from 1 to 25 wt. % carbon black. The carbon black has a particle size of from 10 to 100 nm. The polystyrene foams are produced predominantly by the extrusion method and have a density of 32-40 g/l. In addition, the production of particulate polystyrene containing blowing agent by mixing a carbon black concentrate in polystyrene together with blowing agents into a polystyrene melt and extruding and granulating the mixture is described. This is a rather complicated procedure.

U.S. Pat. No. 5,373,026 discloses similar foams in which the size of the carbon black particles is greater than 150 nm.

EP-A 620 246 discloses expanded polystyrene foam moldings containing a particulate athermanous material, in particular carbon black or graphite. The density of the moldings is less than 20 g/l. The incorporation of the particles into the moldings is carried out by coating the surface of the prefoamed polystyrene beads or by embedding into the not yet foamed polystyrene granules. However, the distribution of particles on the surface of the polystyrene particles greatly impairs the fusion of the prefoamed beads and consequently leads to low-quality foams; in addition, the particles can be rubbed off the surface of the moldings. In both cases, the particles are not homogeneously distributed in the interior of the polystyrene particles.

U.S. Pat. No. 6,130,265 discloses a compatibilized carbon black useful in melt processing of plastic material. The carbon black is coated with a compatibilizing agent, which enhances the dispersibility of the carbon black in a melt of the plastic material.

U.S. Pat. No. 6,130,265 discloses expandable styrene polymers containing graphite particles formed by polymerizing styrene in aqueous suspension in the presence of graphite particles.

U.S. Pat. No. 6,258,865 discloses a closed-cell polymeric foam formed using oil-containing furnace black as an insulation enhancer.

In the prior art known to date, the insulating properties of foamed articles made from expandable polystyrene are not optimal and/or are not consistent. Further, attempts to use athermanous materials in conjunction with oils and/or compatibilizing agents, although somewhat successful in increasing the insulation value of the article result in an undesirable decrease in the strength related physical properties of the foam and/or foamed article.

Thus, there is a need in the art for an improved expandable polymer particle that can be prepared using a simple process and which can be processed to form expanded polymer foams having a low density and a particularly low thermal conductivity while having good processing properties and desirable physical properties.

### SUMMARY OF THE INVENTION

The present invention provides a thermoplastic composition prepared by:
providing a mixture of ethylenically unsaturated monomers containing at least 25 weight percent of one or more styrenic monomers, from 0.001 to 5 weight percent of one or more waxes, from 0.001 to 5 weight percent of one or more white oils, and from 0.01 to 10 weight percent of a particulate solid, the weight percentages based on the weight of the mixture;
polymerizing the monomers in the mixture in the presence of one or more free radical catalysts to form expandable particles;
incorporating a blowing agent into the expandable particles; and
at least partially expanding the expandable particles to provide expanded particles.

The present invention also provides a process for the preparation of porous particles that includes:
providing a mixture of ethylenically unsaturated monomers containing at least 25 weight percent of one or more styrenic monomers, from 0.001 to 5 weight percent of one or more waxes, from 0.001 to 5 weight percent of one or more white oils, and from 0.01 to 10 weight percent of a particulate solid, the weight percentages based on the weight of the mixture;
polymerizing the monomers in the mixture in the presence of one or more free radical catalysts to form expandable particles.

The present invention further provides expanded and pre-expanded particles as described above and/or prepared according to the above-described method.

The present invention additionally provides a foamed article prepared by feeding the above-described pre-expanded particles to a mold, heating the mold and pre-expanded particles to a temperature sufficient to further expand the particles and cause the pre-expanded particles to soften and stick together, and cooling the mold to provide a foamed article.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about.” Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term “ethylenically unsaturated monomers” refers to a carbon based molecule that can undergo a polymerization reaction when exposed to a free radical source.

As used herein, the term “styrenic monomers” refers to ethylenically unsaturated monomers that include an aromatic moiety. As such, styrenic monomers are not limited to styrene, but include C₁-C₃₂ linear, branched and cyclic molecules that contain at least one aromatic group and at least one polymerizable double bond.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, homopolymers, copolymers, graft copolymers, and blends and combinations thereof.

Unless otherwise specified, all molecular weight values are determined using gel permeation chromatography (GPC) using appropriate polystyrene standards. Unless otherwise indicated, the molecular weight values indicated herein are weight average molecular weights (Mw).

As used herein, the terms “particle”, “bead”, “resin bead”, “unexpanded resin bead” and “unexpanded particle” refer to particles resulting from the polymerization of the mixture as defined below.

As used herein, the terms “expanded resin bead” and “expanded particle” refer to particles that have been impregnated with a blowing agent, at least some of which is subsequently removed (as a non-limiting example heated and expanded followed by evaporation and diffusion out of the bead) in a way that increases the volume of the particles and accordingly decreases their bulk density.

The present invention provides a thermoplastic composition prepared by:
providing a mixture containing ethylenically unsaturated monomers including one or more styrenic monomers, one or more waxes, one or more white oils, and a particulate solid,
polymerizing the monomers in the mixture in the presence of one or more free radical catalysts to form expandable particles;
incorporating a blowing agent into the expandable particles; and

at least partially expanding the expandable particles to provide expanded particles.

Any suitable styrenic monomer can be used in the invention. Suitable styrenic monomers are those that provide the desirable properties in the present composition as described below. Non-limiting examples of suitable styrenic monomers include styrene, p-methyl styrene, α-methyl styrene, tertiary butyl styrene, dimethyl styrene, nuclear brominated or chlorinated derivatives thereof and combinations thereof.

The styrenic monomers can be present in the mixture at a level of at least 25, in some cases at least 30, and in other cases at least 35 weight percent and can be present at up to 99, in some cases up to 95, and in other cases up to 90 weight percent of the mixture. The amount of styrene monomer in the mixture is determined based on the properties desired in the present composition and can be any value or can range between any of the values recited above.

In an embodiment of the invention, the mixture that includes ethylenically unsaturated monomers can optionally also include other monomers selected from maleate-type monomers, olefins, (meth)acrylates, and combinations thereof.

Any suitable maleate-type monomer can be used in the invention. Suitable maleate-type monomers are those that provide the desirable properties in the present composition as described below and include anhydrides, carboxylic acids and alkyl esters of maleate-type monomers, which include, but are not limited to maleic acid, fumaric acid and itaconic acid. Specific non-limiting examples of suitable maleate-type monomers include maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

Any suitable olefin can be used in the invention. Suitable olefins are those that provide the desirable properties in the present composition as described below and include 1-butene, isobutylene, 2-butene, isoprene, butadiene, diisobutylene, 1-pentene, 2-pentene, 1-hexene, 2-hexene, 3-hexene, 1,3-hexadiene, 2,4-hexadiene, isoprenol, ethylene, propylene and combinations thereof.

Any suitable (meth)acrylate monomer can be used in the invention. Suitable (meth)acrylate monomers are those that provide the desirable properties in the present composition as described below and include C₁-C₁₂ linear, branched or cyclic alkyl (meth)acrylates and combinations thereof.

When present, the other monomers can be present in the mixture at a level of at least 1, in some cases at least 5, and in other cases at least 10 weight percent and can be present at up to 50, in some cases up to 40, and in other cases up to 30 weight percent of the mixture. The amount and type of other monomers in the mixture is determined based on the properties desired in the present composition and can be any value or can range between any of the values recited above.

In an embodiment of the invention, the mixture includes one or more chain transfer agents. Any chain transfer agent that effectively controls the molecular weight of the resulting polymer or copolymers can be used in the invention. Non-limiting examples of suitable chain transfer agents include alkyl mercaptans according to the structure R—SH, where R represents a C₁ to C₃₂ linear, branched or cyclic alkyl or alkenyl group; mercaptoacids according to the structure HS—R—COOX, where R is as defined above and X is H, a metal ion, N⁺H₄ or a cationic amine salt; dimers or cross-dimers of α- methylstyrene, methyl methacrylate, hydroxy ethylacrylate, benzyl methacrylate, allyl methacrylate, methacrylonitrile, glycidyl methacrylate, methacrylic acid, tert-butyl methacrylate, isocyanatoethyl methacrylate, meta-isopropenyl-α,α-dimethyl isocyanate, ω-sulfoxyalkyl methacrylates and alkali salts thereof. Suitable dimers that can be used in the invention are disclosed, for example, in U.S. Patent Application Publication No. 2004/0176527, the relevant portions of which are herein incorporated herein by reference.

The waxes used in the present invention, at atmospheric pressure, are typically solid at 20° C. and below, in some cases 25° C. and below, and in other cases 30° C. and below, and are liquid at 125° C. and above, in some cases 150° C. and above, and in other cases 200° C. and above. The physical properties of the waxes used in the present invention are selected to provide the desirable properties in the present composition as described below.

In an embodiment of the invention, the waxes are selected from natural and/or synthetic waxes. As such, the waxes used in the present invention can be one or more materials selected from C₁₀ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl alcohols, C₁₀ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl carboxylic acids and/or their corresponding ammonium and metal salts and C₁ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl esters, C₁₀ to C₃₂, in some instances C₁₂ to C₃₂, in some cases C₁₄ to C₃₂, and in other cases C₁₆ to C₃₂ linear, branched or cyclic alkyl, alkenyl, aryl, alkaryl, or aralkyl hydrocarbons, polyethylene, polypropylene, polyester, and combinations thereof, so long as they meet a combination of liquid and solid temperatures as defined above.

The wax can be present in the mixture at a level of at least 0.001, in some cases at least 0.01, in other cases at least 0.1, and in some instances 1 weight percent and can be present at up to 5, in some cases up to 4, and in other cases up to 3 weight percent of the mixture. The amount of wax in the mixture is determined based on the properties desired in the present composition and can be any value or can range between any of the values recited above.

The white oils used in the present composition are typically liquid at atmospheric pressure and 20° C. and above, in some cases 15° C. and above, in other cases 10° C. and above, in some instance 5° C. and above and in other instance 0° C. and above. As such, the white oils used in the present invention can be one or more materials selected from C₁₀ to C₃₂, in some cases C₁₂ to C₂₄, and in other cases C₁₂ to C₂₂ linear, branched or cyclic alkyl hydrocarbons, so long as the physical properties described above are present.

The white oil can be present in the mixture at a level of at least 0.001, in some cases at least 0.01, in other cases at least 0.1, and in some instances 1 weight percent and can be present at up to 5, in some cases up to 4, and in other cases up to 3 weight percent of the mixture. The amount of white oil in the mixture is determined based on the properties desired in the present composition and can be any value or can range between any of the values recited above.

Any suitable particulate solid can be used in the present invention so long as it improves the insulating properties of the composition. In an embodiment of the invention, the particulate solid can be selected from carbon black, graphite, titanium dioxide, calcium carbonate, barium sulfate, calcium sulfate, pigments, silicon dioxide, talc, clay, zeolites, diatomaceous earth, magnesium oxide, aluminum, aluminum oxides, zirconium, zirconium oxides, cokes, chars, diamond dust, and combinations thereof.

Advantageously, the particulate solid is homogeneously distributed throughout the polymer formed by polymerizing the above-mentioned ethylenically unsaturated monomers.

In another embodiment of the invention, the particulate solid has a particle size of at least 0.001 μm, in some cases at least 0.01 μm, in other cases at least 0.1 μm, and in some instances 1 μm and can be up to 5 μm, in some cases up to 4 μm, and in other cases up to 3 μm. The particle size can be determined using electron microscopy or other suitable microscopic techniques. The particle size of the particulate solid is determined based on the properties desired in the present composition and can be any value or can range between any of the values recited above.

In a further embodiment of the invention, the aspect ratio of the particulate solid particles can be from at least about 1, in some cases at least about 1.5 and in other cases at least about 2 and can be up to about 5, in some cases up to about 4 and in other cases at least up to about 3. The aspect ratio is selected to provide desirable insulating properties in foamed articles according to the invention. The aspect ratio of the particulate solid particles can be any value or range between any of the values recited above. As a non-limiting example, the aspect ratio can be measured by scanning electron microscopy or light scattering.

The particulate solid can be present in the mixture at a level of at least 0.01, in some cases at least 0.1, in other cases at least 1, and in some instances at least 2 weight percent and can be present at up to 10, in some cases up to 8, and in other cases up to 5 weight percent of the mixture. The amount of particulate solid in the mixture is determined based on the properties desired in the present composition and can be any value or can range between any of the values recited above.

In an embodiment of the invention, impact modifiers, which in many cases are elastomeric polymers, can optionally be included in the mixture. The impact modifying and/or elastomeric polymers are combined with the mixture and, in a particular embodiment of the invention, are present in the polymerization mixture at a level of at least 0.1%, in some cases at least 0.5%, in other cases at least 1%, and in some instances at least 2% and can be present at up to 25%, in some cases up to 20%, in other cases up to 15%, and in some situations up to 10% by weight based on the weight of the polymer composition. The impact modifying and/or elastomeric polymers can be present at any level or can range between any of the values recited above.

Any suitable elastomeric polymer can be used in the invention. In some embodiments of the invention, combinations of elastomeric polymers are used to achieve desired properties. Suitable elastomeric polymers are those that provide the desirable properties in the composition as described below and are desirably capable of resuming their shape after being deformed.

Suitable impact modifying and/or elastomeric polymer that can be used in the invention include, but are not limited to homopolymers of butadiene or isoprene or other conjugated diene, and random, block, AB diblock, or ABA triblock copolymers of a conjugated diene (non-limiting examples being butadiene and/or isoprene) with a styrenic monomer as defined above and/or acrylonitrile.

In a particular embodiment of the invention, the elastomeric polymers include one or more block copolymers selected from diblock and triblock copolymers of styrene-butadiene, styrene-butadiene-styrene, styrene-isoprene, styrene-isoprene-styrene, partially hydrogenated styrene-isoprene-styrene and combinations thereof.

In an embodiment of the invention, the elastomeric polymer has a number average molecular weight (Mn) greater than 6,000, in some cases greater than 8,000, and in other cases greater than 10,000 and a weight average, molecular weight (Mw) of at least 25,000 in some cases not less than about 50,000, and in other cases not less than about 75,000 and the Mw can be up to 500,000, in some cases up to 400,000 and in other cases up to 300,000. The weight average molecular weight of the elastomeric polymer can be any value or can range between any of the values recited above.

Non-limiting examples of suitable block copolymers that can be used in the invention include the STEREON® block copolymers available from the Firestone Tire and Rubber Company, Akron, Ohio; the ASAPRENE™ block copolymers available from Asahi Kasei Chemicals Corporation, Tokyo, Japan; the KRATON® block copolymers available from Kraton Polymers, Houston, Tex.; and the VECTOR® block copolymers available from Dexco Polymers LP, Houston, Tex.

The present composition can be formed by polymerizing the monomers in the mixture in the presence of one or more free radical catalysts, forming expandable particles.

In an embodiment of the invention, the polymerizing step is carried out in an agitated reaction vessel. The polymerization temperature can be at least 50° C., in some cases at least 60° C., and in other cases at least 65° C. and can be up to 110° C., in some cases up to 100° and in other cases up to 90° depending on the monomers and initiators employed. The polymerization temperature can be any of the temperatures recited above and can range between any of the temperatures recited above.

Further, the polymerizing step can require at least 1, in some cases at least 1.5, and in other cases at least 2 hours and can require up to about 10 hours, in some cases up to about 8 hours and in other cases up to about 6 hours depending on the temperatures, monomers and initiators employed. The time for the polymerization step can be any of the length of times recited above and can range between any of the length of times recited above.

Polymerization of the polymerization mixture can be accomplished by thermal polymerization, typically involving free-radical generating initiators. Non-limiting examples of free-radical initiators that can be used include benzoyl peroxide, 2,4-dichlorobenzoyl peroxide, di-tert-butyl peroxide, tert-butyl peroxybenzoate, dicumyl peroxide, cumene hydroperoxide, diisopropylbenzene hydroperoxide, diisopropyl peroxy-dicarbonate, tert-butyl perisobutyrate, tert-butyl peroxyisopropylcarbonate, tert-butyl peroxypivalate, methyl ethyl ketone peroxide, stearoyl peroxide, tert-butyl hydroperoxide, lauroyl peroxide, azo-bis-isobutyronitrile and mixtures thereof.

Generally, the initiator is included in the range of 0.001 to 1.0% by weight, and in some cases on the order of 0.005 to 0.5% by weight of the polymerization mixture, depending upon the monomers and the desired polymerization cycle.

In some cases, the required total amount of initiator is added simultaneously with the feedstock when the feedstock is introduced into the reactor.

Customary additives known in the art, such as stabilizers, antioxidants, lubricants, fillers, pigments, plasticizers, etc., can be added to the polymerization mixture. If desired, small amounts of antioxidants, such as alkylated phenols, e.g., 2,6-di-tert-butyl-p-cresol, phosphates such as trinonyl phenyl phosphite and mixtures containing tri (mono and dinonyl phenyl) phosphates, can be included in the feed stream. Such materials, in general, can be added at any stage during the polymerization process.

The polymerization process itself and/or appropriate post-polymerization processing steps known in the art provide the polymerized mixture in particulate form, from which expandable particles are provided by incorporating a suitable blowing agent into the particles.

In an embodiment of the invention, the expandable beads or particles are prepared in a suspension polymerization process in which ethylenically unsaturated monomers are polymerized in aqueous suspension in the presence of the particulate solid in the mixture defined above and from 0.1 to 1% by weight of a free radical initiator, where a C₂₋₆ organic blowing agent is added before, during or after the polymerization, where the amount of blowing agent is from 0.5 to 4%, in some cases 0.5 to 2.5% by weight, based on the amount of monomers, to yield expandable beads or particles. For the suspension polymerization, many methods and initiators are known. As non-limiting examples, the methods disclosed in U.S. Pat. Nos. 2,656,334, 3,817,965, 5,266,602, and/or 6,538,042 can be used, the relevant portions of which are herein incorporated by reference. The initiators mentioned therein are also applicable in the preparation of the particles of the present invention. Particularly suitable are organic peroxy compounds, such as peroxides, peroxy carbonates and peresters. Typical examples of such peroxy compounds are C₆₋₂₀ acyl peroxides, such as decanoyl peroxide, benzoyl peroxide, octanoyl peroxide, stearyl peroxide, peresters, such as t-butyl perbenzoate, t-butyl peracetate, t-butyl perisobutyrate, hydroperoxides and dihydrocarbyl peroxides, such as those containing C₃₋₁₀ hydrocarbyl moieties, including di-isopropyl benzene hydroperoxide, di-t-butyl peroxide, t-butylperoxy-(2-ethylhexyl)-carbonate, dicumyl peroxide or combinations thereof. Other initiators different from peroxy compounds are also possible, such as α,α′-azobis-isobutyronitrile.

The polymerization directly provides expandable particles.

The expandable particles can be impregnated using any conventional method with a suitable blowing agent. Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g. CFC's and HCFC'S, which boil at a temperature below the softening point of the polymer chosen. Mixtures of these aliphatic hydrocarbon blowing agents can also be used.

The impregnation can be conducted in many ways. However, it is preferred to impregnate the particles according to this invention by an inorganic gas by exposing the particles to the gas at temperatures ranging from 0 to 95° C. In this way the voids in the particles are filled with the gas without the polyvinylarene being heated such that it deforms. Such deformation might have a detrimental effect on the structure and properties of the voids and thereby it would have a negative impact on the expandability of the resulting impregnated particles. Moreover, the low temperature ensures that the particles remain free flowing and do not stick to each other, which might occur if the impregnation would be conducted at higher temperatures. Preferred temperature ranges are from 0 to 50° C., more preferably from 10 to 30°. Most preferably, the temperature used is room temperature.

The impregnation is suitably such that in the pores of the expandable beads or particles a pressure of 100 to 1,500 kPa gauge, in some cases between 200 and 1,000 kPa gauge, and in other cases between 300 and 800 kPa gauge are achieved. Lower pressures than 100 kPa gauge would mean that the voids would merely be filled with gas, e.g. nitrogen or air, at about atmospheric pressure. Such a replacement would result in a insufficient expansion, if any. Pressures higher than 1,500 kPa gauge are possible, but these are undesirable for economical and safety reasons. Suitably, the external pressure applied is the same as the desired pressure in the pores of the porous particle.

Alternatively, water can be blended with these aliphatic hydrocarbons blowing agents or water can be used as the sole blowing agent as taught in U.S. Pat. Nos. 6,127,439; 6,160,027; and 6,242,540 in these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

Any suitable blowing agents can be used in the present invention so long as they expand and evaporate under particle expansion conditions to form the desired expanded particles as discussed below. Suitable blowing agents include, but are not limited to nitrogen, sulfur hexafluoride (SF₆), argon, carbon dioxide, 1,1,1,2-tetrafluoroethane (HFC-134a), 1,1,2,2-tetrafluoroethane (HFC-134), 1,1,1,3,3-pentafluoropropane, difluoromethane (HFC-32), 1,1-difluoroethane (HFC-152a), pentafluoro-ethane (HFC-125), fluoroethane (HFC-161) and 1,1,1-trifluoroethane (HFC-143a), methane, ethane, propane, n-butane, isobutane, n-pentane, isopentane, cyclopentane and neopentane, azodicarbonamide, azodiisobutyro-nitrile, benzenesulfonylhydrazide, 4,4-oxybenzene sulfonyl-semicarbazide, p-toluene sulfonyl semi-carbazide, barium azodicarboxylate, N,N′-dimethyl-N,N′-dinitrosotereph-thalamide, trihydrazino triazine, mixtures of citric acid and sodium bicarbonate, and combinations thereof.

Typically, the blowing agents are added to the particles at a level of at least 2%, in some cases at least 2.5%, in other cases at least 3%, and in some instances at least 4% and can be up to 15%, in some cases up to 12.5%, and in other cases up to 10% by weight based on the polymer composition. The amount of blowing agent used can be any value or can range between any of the values recited above.

After impregnation with a blowing agent, the impregnated particles obtained are suitably expanded. The particles can be expanded to an apparent density do or a bulk density of at least 8 kg/m³ (0.5 lb/ft³), in some cases at least 20 kg/m³ (1.25 lb/ft³), in other cases at least 50 kg/m³ (3.1 lb/ft³), in some situations at least 100 kg/m³ (6.2 lb/ft³), in some circumstances at least 200 kg/m³ (12.5 lb/ft³), in other circumstances at least 250 kg/M³ (15.6 lb/ft³), and in particular circumstances at least 300 kg/m³ (18.7 lb/ft³). Also, the bulk density can be as high as 600 kg/m³ (37.5 lb/ft³), in some situations 550 kg/m³ (34.3 lb/ft³), in some instances up to 500 kg/m³ (31.2 lb/ft³), in some cases up to 450 kg/m³ (28.1 lb/ft³), and in other cases up to 400 kg/m³ (25 lb/ft³) The apparent density do or bulk density of the expanded particles can be any value or range between any of the values recited above.

The expansion step can be carried out by heating the impregnated resin beads or particles via any conventional heating medium, such as steam, hot air, hot water, or radiant heat. One generally accepted method for accomplishing the pre-expansion of impregnated resin beads or particles is taught in U.S. Pat. No. 3,023,175.

In a particular embodiment of the invention, the expandable particles are exposed to saturated steam over atmospheric pressure to reach a final temperature of 105° C. for 30 seconds, expand to form the expanded particles having an apparent density which is at most three times lower than the density of the expandable particles.

After expansion or pre-expansion, the at least partially expanded beads or particles contain up to 2%, in some cases up to 1.5%, and in other cases up to 1% by weight of the blowing agent.

The expanded particles or resin beads can include customary ingredients and additives, such as flame retardants, pigments, dyes, colorants, plasticizers, mold release agents, stabilizers, ultraviolet light absorbers, mold prevention agents, antioxidants, rodenticides, insect repellants, and so on.

The expanded resin beads or particles can have an average particle size of at least 0.3, in some circumstances at least 0.5, in some cases at least 0.75, in other cases at least 0.9 and in some instances at least 1 mm and can be up to 8, in some circumstances up to 6, in other circumstances up to 5, in some cases up to 4, in other cases up to 3, and in some instances up to 2.5 mm. The average particle size of the expanded resin beads can be any value and can range between any of the values recited above. The average particle size of the expanded resin beads or particles can be determined using laser diffraction techniques or by screening according to mesh size using mechanical separation methods well known in the art.

In an embodiment of the invention, and in order to provide expanded resin beads or particles with desirable physical properties, the expanded particles are not expanded to their maximum expansion factor; as such an extreme expansion yields particles with undesirably thin cell walls and insufficient toughness and strength. As such, the resin beads or particles can be expanded at least 50%, in some cases at least 75%, and in other cases at least 100% of their unexpanded size and are expanded up to 300%, in some cases up to 250%, and in other cases up to 200% of their unexpanded size. The resin beads or particles can be expanded to any degree indicated above or the expansion can range between any of the values recited above.

The expandable resin beads or particles obtained according to the invention can be formed into a foamed shaped article of a desired configuration by pre-foaming the beads and foaming and shaping them in a mold cavity. More specifically, a foamed article can be prepared by feeding the expanded resin beads or particles described above to a mold, heating the mold and expanded resin beads or particles to a temperature sufficient to further expand the particles and cause the expanded particles to soften and stick together, and cooling the mold to provide a foamed article.

The resulting foamed shaped article has superior insulating properties while not diminishing the strength of the foamed shaped article. It has been found that although white oil can be added in sufficient quantities to improve insulating properties, the levels required result in a decrease in strength of the resulting foamed shaped article. However, in the present invention it has been found that a combination of wax and white oil overcomes this problem and improved insulating properties can be provided with no loss in strength.

As such, foamed shaped articles made from beads containing a combination of particulate solids, wax and white oil according to the invention, have lower lamda values than the same articles made from beads having particulate solids and no wax and/or white oil at the same density.

Also, foamed shaped articles made from beads containing a combination of particulate solids, wax and white oil according to the invention, have higher bending strengths than the similar articles made from beads having particulate solids and high levels of white oil (and no wax) that provide similar insulating properties. As such, when compared to articles where enough white oil is added to provide similar insulating properties to the articles of the present invention, the bending strength of articles made according to the invention can be at least 5 KPa, in some cases at least 10 KPa and in other cases 15 KPa greater than articles made from beads having enough white oil (and no wax) added to provide similar insulating properties to the articles of the present invention.

The thermoplastic composition of the present invention typically contains less than 3%, in some cases less than 2%, and in other cases less than 1% by weight of water.

In particular embodiments of the invention, the mixture contains from 70 to 95 weight percent of styrene, from 0.01 to 0.15 weight percent of one or more waxes, from 0.1 to 2 weight percent of one or more white oils, and from 2 to 8 weight percent of a particulate solid, where the weight percentages based on the weight of the mixture, in order to provide thermoplastic compositions, expandable particles, expanded particles and foamed articles with the above-described properties.

The present invention will further be described by reference to the following examples. The following examples are merely illustrative of the invention and are not intended to be limiting. Unless otherwise indicated, all percentages are by weight.

### EXAMPLES

Polystyrene particles were prepared by a suspension polymerization process as indicated in the table below (all ingredients percent by weight). Demineralized water, styrene, conventional suspension stabilizers, polyethylene wax, white oil and carbon black were mixed in a reaction vessel. The polymerization was started by raising the temperature to 86° C. and by addition of benzoyl peroxide (BPO) initiator (0.65% wt). After around 6 hours, pentane (mixture of 75% wt n-pentane and 25% wt isopentane) was added and the temperature was raised to about 120° C. where it was held for 2 hours. After finishing the polymerization, the reaction mixture was cooled, and the resulting expandable polystyrene beads were recovered all having a mean bead size of about 1.2 mm and unreacted styrene content of less than 1000 ppm.

| | Sample | | | | | |
|---|---|---|---|---|---|---|
| | A | B | C | D | E | F |
| Water | 53.6 | 53.47 | 53.35 | 53.05 | 53.23 | 53.21 |
| Styrene | 40.15 | 40.1 | 39.9 | 39.8 | 39.94 | 39.8 |
| Stabilizers | 0.35 | 0.35 | 0.35 | 0.35 | 0.35 | 0.35 |
| H2 Wax | 0 | 0.08 | 0 | 0 | 0.08 | 0.04 |
| White Oil | 0 | 0 | 0.4 | 0.8 | 0.4 | 0.6 |
| BPO | 0.07 | 0.07 | 0.07 | 0.07 | 0.07 | 0.07 |
| Carbon Black | 2.43 | 2.43 | 2.43 | 2.43 | 2.43 | 2.43 |
| Pentane | 3.5 | 3.5 | 3.5 | 3.5 | 3.5 | 3.5 |
| Mn | 95,000 | 96,000 | 96,000 | 96,000 | 96,000 | 96,000 |
| Mw | 245,000 | 229,000 | 229,000 | 236,000 | 241,000 | 239,000 |
| Pentane in bead | 5.4 | 6.3 | 6.3 | 6.3 | 6.3 | 6.3 |

The samples were pre-expanded at 0.2 bar steam pressure using a vertical handle batch expander. Times were varied to provide different densities. The pre-expanded beads were dried at 70° C. The pre-expanded beads were molded (300×300×50 mm) on a Kurtz K45 contour molding machine using standard processing conditions over 0.5-1.2 bar steam pressure. The resulting foam tiles were conditioned in an oven at 70° C. for 48 hours prior to evaluation. The results are shown in the table below.

| | | | 10% | |
|---|---|---|---|---|
| | | Bending | Compression | |
| | Density | Strength | Strength | Lamda |
| | (kg/m³) | (KPa) | (KPa) | (mW/m · K) |
| Sample A | 14.8 | 130 | 59 | 31.5 |
| | 15.7 | 150 | 68 | 31.1 |
| | 16.3 | 150 | 71 | 30.4 |
| Sample B | 13.3 | 165 | 58 | 34.8 |
| | 17.8 | 245 | 87 | 32.4 |
| | 20.7 | 300 | 119 | 31.3 |
| Sample C | 13.1 | 170 | 52 | 34.7 |
| | 16.2 | 215 | 61 | 32.8 |
| | 23.0 | 310 | 122 | 31.6 |
| Sample D | 16.2 | 180 | 78 | 32.7 |
| | 17.3 | 195 | 83 | 32.1 |
| | 22.2 | 315 | 117 | 31.0 |
| Sample E | 16.2 | 200 | 75 | 33.1 |
| | 17.0 | 230 | 79 | 32.6 |
| | 22.3 | 320 | 119 | 31.0 |
| Sample F | 15.6 | 180 | 73 | 32.7 |
| | 17.3 | 210 | 83 | 31.8 |
| | 21.8 | 265 | 117 | 30.7 |

As the data show, at low densities (about 16 kg/m³), the compositions according to the present invention provide a better combination of insulating values (lamda) and strength than when no waxes and oils are used in the formulation as shown by comparing Sample E and Sample F with Sample A. Generally, lower lamda values were observed when the combination of white oil and wax were used (Samples E and F) than when oil (Samples C and D) or wax (Sample B) were used alone, although at higher levels of white oil (Sample D) the differences are small. However, the bending strength tends to deteriorate when higher levels of white oil are used (Sample D) when compared to the combination of white oil and wax (Samples E and F).

The data demonstrate that making EPS beads using a combination of white oil and wax along with particulate solids according to the invention enables the production of molded articles having improved insulating properties while maintaining the strength of the molded articles.

The present invention has been described with reference to specific details of particular embodiments thereof. It is not intended that such details be regarded as limitations upon the scope of the invention except insofar as and to the extent that they are included in the accompanying claims.

We claim:

1. A thermoplastic composition prepared by:
A) providing a mixture of ethylenically unsaturated monomers comprising at least 25 weight percent of one or more styrenic monomers, from 0.001 to 5 weight percent of one or more waxes, from 0.001 to 5 weight percent of one or more white oils, and from 0.01 to 10 weight percent of a particulate solid, said weight percentages based on the weight of the mixture;
B) polymerizing the monomers in the mixture in the presence of one or more free radical catalysts to form expandable particles;
C) incorporating a blowing agent into the expandable particles; and
D) at least partially expanding the expandable particles to provide expanded particles.

2. The composition according to claim 1, wherein the styrenic monomers are selected from the group consisting of styrene, α-methyl styrene, p-methyl styrene, tertiary butyl styrene, dimethyl styrene, the nuclear brominated or chlorinated derivatives thereof, and combinations thereof.

3. The composition according to claim 1, wherein the polymerizing step in C) is carried out in an agitated reaction vessel at from about 600 to about 110° C. for a time of from about 1 to about 10 hours.

4. The composition according to claim 1, wherein the particulate solid is one or more selected from the group consisting of carbon black, graphite, titanium dioxide, calcium carbonate, barium sulfate, calcium sulfate, pigments, silicon dioxide, talc, clay, zeolites, diatomaceous earth, magnesium oxide, aluminum, aluminum oxides, zirconium, zirconium oxides, cokes, chars, diamond dust, and combinations thereof.

5. The composition according to claim 1, wherein the particulate solid has a particle size of from 0.001 to 5 μm.

6. The composition according to claim 1, wherein the waxes are natural and/or synthetic waxes.

7. The composition according to claim 1, wherein the waxes are solid at 20° C., liquid at 125° C. (atmospheric pressure) and include one or more materials selected from the group consisting of C₁₀ to C₃₂ linear, branched or cyclic alkyl, alkenyl, aryl, alkaryl, or aralkyl alcohols, C₁₀ to C₃₂ linear, branched or cyclic alkyl, alkenyl, aryl, alkaryl, or aralkyl carboxylic acids and/or their corresponding ammonium and metal salts and C₁ to C₃₂ linear, branched or cyclic alkyl, alkenyl, aryl, alkaryl, or aralkyl esters, C₁₀ to C₃₂ linear, branched or cyclic alkyl, alkenyl, aryl, alkaryl, or aralkyl hydrocarbons, polyethylene, polypropylene, polyester, and combinations thereof.

8. The composition according to claim 1, wherein the white oils are liquid at 20° C. (atmospheric pressure) and comprise C₁₀ to C₃₂ linear, branched or cyclic alkyl hydrocarbons.

9. The composition according to claim 1, wherein the blowing agent is one or more selected from the group consisting of nitrogen, sulfur hexafluoride (SF₆), argon, carbon dioxide, 1,1,1,2-tetrafluoroethane (HFC-134a), 1,1,2,2-tetrafluoroethane (HFC-134), 1,1,1,3,3-pentafluoropropane, difluoromethane (HFC-32), 1,1-difluoroethane (HFC-152a), pentafluoro-ethane (HFC-125), fluoroethane (HFC-161) and 1,1,1-trifluoroethane (HFC-143a), methane, ethane, propane, n-butane, isobutane, n-pentane, isopentane, cyclopentane and neopentane, azodicarbonamide, azodiisobutyro-nitrile, benzenesulfonylhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, mixtures of citric acid and sodium bicarbonate, and combinations thereof.

10. The composition according to claim 1, wherein the expandable particles are expanded such that the expanded particle has a volume of from 50% to 300% greater than the volume of the unexpanded expandable particle.

11. A foamed article prepared by feeding the expanded particles of claim 10 to a mold, heating the mold and expanded particles to a temperature sufficient to further expand the particles and cause the expanded particles to soften and stick together, and cooling the mold to provide a foamed article.

12. The composition according to claim 1, wherein the expandable particles have an apparent density do of from 600 to 200 kg/m³.

13. The composition according to claim 1 containing less than 3% by weight of water.

14. The composition according to claim 1, wherein the expandable particles are exposed to saturated steam over atmospheric pressure to reach a final temperature of 105° C. for 30 seconds and expand to form the expanded particles having an apparent density which is at most three times lower than the density of the expandable particles.

15. The composition according to claim 1 further comprising one or more additives selected from the group consisting of flame retardants, dyes, colorants, mold release agents, stabilizers, ultraviolet light absorbers, mold prevention agents, antioxidants, rodenticides, insect repellants, and combinations thereof.

16. A process for the preparation of porous particles comprising:
providing a mixture of ethylenically unsaturated monomers comprising at least 25 weight percent of one or more styrenic monomers, from 0.001 to 5 weight percent of one or more waxes, from 0.001 to 5 weight percent of one or more white oils, and from 0.01 to 10 weight percent of a particulate solid, said weight percentages based on the weight of the mixture;
polymerizing the monomers in the mixture in the presence of one or more free radical catalysts to form expandable particles;
incorporating a blowing agent into the expandable particles; and
pre-expanding the expandable particles to an apparent density of 600 to 200 kg/M³ to form an expanded particle having a pore structure and containing 2% by weight or less of the blowing agent.

17. The process according to claim 16, wherein expandable particles are prepared in a suspension polymerization process in which the mixture of monomers is polymerized in an aqueous suspension in the presence of the waxes, white oils, and particulate solid, wherein a C₂₋₆ organic blowing agent is added before, during or after the polymerization, wherein the amount of blowing agent is from 0.5 to 4% by weight, based on the amount of monomers, to provide expandable particles.

18. The process according to claim 16, wherein the styrenic monomers are selected from the group consisting of styrene, α-methyl styrene, p-methyl styrene, tertiary butyl styrene, dimethyl styrene, the nuclear brominated or chlorinated derivatives thereof, and combinations thereof.

19. The process according to claim 16, wherein the polymerizing step is carried out in an agitated reaction vessel at from about 600 to about 110° C. for a time of from about 1 to about 10 hours.

20. The process according to claim 16, wherein the particulate solid is one or more selected from the group consisting of carbon black, graphite, titanium dioxide, calcium carbonate, barium sulfate, calcium sulfate, pigments, silicon dioxide, talc, clay, zeolites, diatomaceous earth, magnesium oxide, cokes, chars, diamond dust, and combinations thereof.

21. The process according to claim 16, wherein the particulate solid has a particle size of from 0.001 to 5 μm.

22. The process according to claim 16, wherein the waxes are solid at 20° C., liquid at 125° C. (atmospheric pressure) and include one or more materials selected from the group consisting of C₁₀ to C₃₂ linear, branched or cyclic alkyl, alkenyl, aryl, alkaryl, or aralkyl alcohols, C₁₀ to C₃₂ linear, branched or cyclic alkyl, alkenyl, aryl, alkaryl, or aralkyl carboxylic acids and/or their corresponding ammonium and metal salts and C₁ to C₃₂ linear, branched or cyclic alkyl, alkenyl, aryl, alkaryl, or aralkyl esters, C₁₀ to C₃₂ linear, branched or cyclic alkyl, alkenyl, aryl, alkaryl, or aralkyl hydrocarbons, polyethylene, polypropylene, polyester, and combinations thereof.

23. The process according to claim 16, wherein the white oils are liquid at 20° C. (atmospheric pressure) and comprise C₁₀ to C₃₂ linear, branched or cyclic alkyl hydrocarbons.

24. The process according to claim 16, wherein the blowing agent is one or more selected from the group consisting of nitrogen, sulfur hexafluoride (SF₆), argon, carbon dioxide, 1,1,1,2-tetrafluoroethane (HFC-134a), 1,1,2,2-tetrafluoroethane (HFC-134), 1,1,1,3,3-pentafluoropropane, difluoromethane (HFC-32), 1,1-difluoroethane (HFC-152a), pentafluoro-ethane (HFC-125), fluoroethane (HFC-161) and 1,1,1-trifluoroethane (HFC-143a), methane, ethane, propane, n-butane, isobutane, n-pentane, isopentane, cyclopentane and neopentane, azodicarbonamide, azodiisobutyro-nitrile, benzenesulfonylhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, mixtures of citric acid and sodium bicarbonate, and combinations thereof.

25. Pre-expanded particles prepared according to the method of claim 16.

26. A foamed article prepared by feeding the pre-expanded particles of claim 25 to a mold, heating the mold and pre-expanded particles to a temperature sufficient to further expand the particles and cause the pre-expanded particles to soften and stick together, and cooling the mold to provide a foamed article.
